(19) United States
(12) Patent Application Publication
(10) Pub. No.: US 2014/0353898 A1
(43) Pub. Date: Dec. 4, 2014

(54) CLAMPING DEVICE, PARTICULARLY A CLAMPING MODULE

(71) Applicant: Klaus Hofmann, Bruck (DE)

(72) Inventor: Klaus Hofmann, Bruck (DE)

(21) Appl. No.: 14/288,263

(22) Filed: May 27, 2014

(30) Foreign Application Priority Data
Jun. 3, 2013 (DE) 102013105694.6

(51) Int. Cl. B25B 1/18; B23Q 1/44; B23Q 1/26

(52) U.S. Cl. CPC B25B 1/18; B23Q 1/262; B23Q 1/44
USPC 269/218; 269/225

(57) ABSTRACT

A clamping device includes a base part, a clamping element arranged such that it can be displaced relative to the base part in order to transmit a clamping force onto a part to be clamped, and a drive unit that displaceably impinges upon the clamping element. The drive unit has a threaded spindle or a threaded sleeve that can be driven rotationally by a motor to directly or indirectly cooperate with a corresponding part of the clamping element in such a manner that rotationally driving the threaded spindle or threaded sleeve effects a displacement of the clamping element and/or a generation of a clamping force.

The invention relates to a clamping device, more particularly a clamping module, with the characteristics of the preamble of claim 1.

Clamping devices are frequently used in the machine tool field in order to securely fix workpieces while being machined. The clamping devices are frequently designed to be controllable by means of a drive unit in order to be able to generate the required high clamping forces quickly, securely and without great manual effort. It is frequently desired that, after the machining of the workpiece in question, the workpiece can be removed from the machine tool together with the clamping device and fed to another machine tool or stored for further future machining without having to remove the workpiece from the clamping device. In this case, it is necessary that the workpiece remains securely fixed in the clamping device during transport. That is to say, the clamping forces must be largely maintained during transport and/or during storage of the workpiece in the clamped state.

Hydraulically actuated clamping devices have hitherto mainly been used for this purpose. It is disadvantageous in this case that the hydraulics always has rather small leaks and therefore if the workpiece is not connected to a source of pressure or a hydraulics source, it cannot be stored for a long period without the clamping forces diminishing or the clamped workpiece even being released. If the clamped workpiece is being moved together with the clamping device from one machine tool to another machine tool, it is not normally necessary to connect a pressure source to the clamping device during transport, because the leakage is usually sufficiently small that the clamping forces can be maintained to a sufficient extent over a relatively short time. If the clamped workpiece is stored, however, connection to a pressure source is unavoidable with such clamping devices.

Another disadvantage of such hydraulic clamping devices is that the hydraulic medium escapes in case of leakage and leads to corresponding contamination.

The advantage of hydraulic clamping devices, however, is that they can generate high clamping forces with a simultaneously small overall size.

Proceeding from this prior art, the invention addresses the problem of creating a clamping device, particularly a clamping module, that avoids a hydraulic drive unit with the risk of leakage and is simultaneously capable of generating sufficiently high clamping forces with a low overall size.

The invention solves this problem with the characteristics of claim 1.

The invention proceeds from the recognition that, in place of hydraulic actuation, sufficiently high clamping forces can be produced by a simple motor drive that has a threaded spindle that engages with a bore having an internal thread in an axially extending region of the clamping element or which has a rotationally drivable threaded sleeve with an internal thread with which a threaded rod of the drive element engages. In rotational driving of the driven elements, i.e. the threaded spindle or the threaded sleeve, the indirectly or directly cooperating threads of the two elements effect a displacement of the clamping element and/or a generation of the required clamping force. The result is a very simple design.

A further advantage of such a drive unit is that it can be designed to be self-locking in an easy manner, so that the clamping forces can be retained even with the drive deactivated, and without supplying energy.

The clamping device can have a single displaceably driven clamping element, which cooperates with an additional, separate, stationary clamping element, for example. Of course, the clamping device can also have a stationary clamping element that cooperates with the moving clamping element. Finally, the clamping device can also have two clamping elements that can move relative to one another.

According to one embodiment of the invention, the diameter of the threaded spindle or the inside diameter of the threaded sleeve is selected to be sufficiently small that at least 10% of the drive torque, preferably at least 15%, and most preferably at least 25% of the drive torque applied to the drive-side end of the threaded spindle or the threaded sleeve is transmitted to contribute to producing the clamping force that can be derived at the impingement surface of the clamping element.

To explain the dimensioning of the clamping device, an M12x1 thread for a threaded spindle will be assumed, in which case the effective thread flank diameter is 10.8 mm. A value of 40 kN for the axial force to be generated will be assumed. The torque that must be applied to an idealized screw (without friction) in order to generate a predetermined axial force or clamping force F results from the product of the axial force F times the pitch of the thread divided by the product of the effective thread flank diameter and π.

From this it follows that a torque of 6.37 Nm is required for the idealized threaded spindle with an M12x1 thread in order to generate an axial force, and thus a clamping force, of 40 kN.

With a coefficient of friction of 0.14, which is typical for screw calculations, a torque (friction torque) of 30.24 Nm is necessary for overcoming the friction.

If one attempts to reduce the friction by coating the thread materials or by means of special lubricants, a torque of 19.44 Nm results for an assumed reduced coefficient of friction of 0.09.

On the other hand, the torque necessary for overcoming the friction of an axial rolling-contact bearing, on the order of 1-2 Nm, proves to be small or almost negligible.

If one were to forgo an axial rolling-contact bearing and use an axial sliding bearing, then drastically higher values for the torque necessary for overcoming the frictional forces of the axial bearing would result. If an axial sliding bearing with a side face of 20 mm in diameter were assumed, with an assumed coefficient of friction of 0.14, a torque of 56 Nm would have to be exerted to overcome the frictional forces that would result (more precisely, a side face is assumed for which an effective lever arm of 20 mm can be calculated for the calculation of the coefficient of friction).

If one attempts to improve this assumed axial sliding bearing with respect to its coefficient of friction by means of material coatings of the contacting surfaces or by means of special lubricants, then a torque of 36 Nm still results, with an assumed coefficient of friction of 0.09.

In all these example calculations, the above-mentioned value of 40 kN is assumed as the axial force.

With the values above for the individual component torques that must be overcome to overcome the individual friction mechanisms, and with the torque of 6.37 Nm necessary for generating the 40 kN frictional force, it follows that in the non-optimized case (i.e. without a sliding bearing and without thread optimized with respect to frictional force), only approximately 7% of the drive torque contributes to generating the desired axial force or clamping force.

If the axial sliding bearing is replaced with an axial rolling-contact bearing having a required torque of 1.2 Nm for overcoming the bearing friction, then this results in a proportion of approximately 17% of the drive torque that is effective in generating the drive torque necessary for generating the clamping force.

If the thread is further optimized with respect to the coefficients of friction, then approximately 24% of the drive torque contributes to generating the clamping force F.

This example illustrates that particularly the choice of the diameter for the driving thread and the use of an axial bearing for the driving element (threaded spindle or threaded sleeve) are crucial in order to be able to generate the desired clamping force with the smallest possible drive torque that must be generated by the drive motor.

In determining the diameter of the thread for the threaded spindle or the threaded sleeve, it is therefore desirable to select as small a diameter is possible in order to keep the lever that determines the different coefficients of friction, and thus the coefficients of friction themselves, as small as possible. On the other hand, the diameter of the thread must be sufficiently large that the axial forces can be transmitted via the thread without damaging the thread or impermissibly reducing the service life of the thread.

According to an additional configuration of the invention, the pitch of the internal and external threads of the threaded spindle and the bore of the clamping element or the threaded sleeve and the threaded rod can be selected in such a manner, depending on the frictional forces between the respective elements, that self-locking exists in the range up to a maximum predetermined nominal clamping force.

Thereby the remaining part of the drive can be designed in practically any desired manner. In particular, it is not necessary for the motor itself to create the self-locking.

According to one configuration of the invention, the external thread of the threaded spindle and/or the internal thread of the bore in the clamping element, or the internal thread of the threaded sleeve and/or the external thread of the threaded rod can be coated with a coating that reduces the friction, as already mentioned.

Any material that reduces the friction and has sufficient durability when applied to the thread is suitable as a coating in this case. A DLC (diamond-like carbon) coating can be mentioned as an example of such a friction-reducing coating.

According to another embodiment of the invention, in which the clamping device comprises only a single displaceable clamping element, the threaded spindle or the threaded sleeve have a flange region, extending perpendicular to the axis of rotation of the threaded spindle or the threaded sleeve and facing away from the impingement surface of the clamping element, wherein the threaded spindle or the threaded sleeve is supported via this flange region against a stationary axial bearing arranged in or on the base part of the clamping device.

The axial bearing is designed in such a manner that it is capable of absorbing the required maximum axial forces occurring in order for the threaded spindle or the threaded sleeve to be rotatably held in the base part, and the frictional forces counteracting the rotational driving, which result due to the axial bearing of the driving element, i.e. the threaded spindle or the threaded sleeve, are minimized.

According to one configuration of the invention, in which the clamping device has two clamping elements that can be displaced in opposite directions by means of a single drive, a single rotationally drivable threaded spindle of the drive unit can cooperate in a respective threaded region with a the respective threaded bore of each of the two clamping elements, or a single rotationally drivable threaded sleeve of the drive unit can cooperate, directly or indirectly, in a respective threaded region with the respective threaded rod of each of the two clamping elements in such a manner that, in one rotational direction of the drive unit, the two clamping elements are moved in one displacement direction, and the two clamping elements are moved in the other displacement direction in the other rotational direction of the drive unit. This can be achieved, for example, by using a right-hand thread and a left-hand thread, respectively, for the two thread regions of the threaded spindle or the threaded sleeve for the drive unit, each thread cooperating with a respective threaded bore or threaded rod of the two clamping elements.

Such an embodiment results in the advantage that an expensive axial bearing is not necessary.

According to one configuration of the invention, the threaded spindle or the threaded sleeve can have a drive region, which can be formed at an end region of the threaded spindle or the threaded sleeve and is connected directly to the output shaft of the motor or via a gear unit to the output shaft of the motor.

In an embodiment with two oppositely movable clamping elements, the drive region can be provided between the two thread regions of the threaded spindle or the threaded sleeve. This yields a simple and compact construction.

The gear unit can also be designed to be self-locking. According to another configuration, the gear unit can be designed such that self-locking is achieved in connection with the drive component formed by the threaded spindle and the bore in the axial region of the clamping elements or by the threaded sleeve and the threaded rod of the clamping elements.

It goes without saying that the motor can also be designed such that it effects self-locking on its own or together with the other components of the drive unit.

A pneumatic motor, such as a rotary vane motor, is particularly suitable for use as a motor. The use of an electric motor or a hydraulic motor is of course also possible.

In the preferred embodiment of the invention, the motor is arranged in the base part substantially alongside and/or underneath the threaded bore of the clamping element and the threaded spindle of the drive unit, or alongside and/or below the threaded rod of the clamping element and the threaded sleeve of the drive unit. In the embodiment with two oppositely displaceable clamping elements, the motor can also be arranged in the axial region between the two threaded bores or threaded sleeves of the clamping elements alongside and/or underneath the axis of the threaded bores or threaded sleeves.

A clamping device or a clamping module with a very small length is achieved in this manner. This is often desirable if multiple clamping devices or clamping modules must be arranged on a common rail of a predetermined limited length.

An arrangement of the motor in the base part alongside the clamping element is made possible in particular because the motor only has to generate a relatively small torque and therefore can have a small overall size, particularly a small width/thickness in relation to the motor shaft. Thus, the width of the clamping device for the clamping module can be selected to be less than or equal to the width of the impingement surface of the clamping element or the clamping jaw.

The motor can be arranged such that the longitudinal axis aligned with the axis of rotation of the output shaft runs parallel to the axis of rotation of the threaded spindle or the threaded sleeve.

The output shaft of the motor can be coupled in a simple manner to the threaded spindle or the threaded sleeve by means of one or more pinions in this case.

According to another configuration of the invention, a plurality of bearing rollers can be provided between the external thread of the threaded spindle for the drive unit and the internal thread of the bore in the axial region of the clamping element, or between the internal thread of the threaded sleeve for the drive unit and the external thread of the threaded rod for the clamping element. The friction between the internal and external threads of the cooperating elements can be drastically reduced with such a threaded roller drive. It is easy to achieve moments of friction of less than 5 Nm down to a range below 2 Nm in this way.

If one assumes only a moment of friction of 5 Nm for such a threaded roller drive, for example, then for the above-explained example of a threaded spindle with an M12x1 thread, a value of approximately 51% of the drive torque active for producing the clamping force results.

According to another configuration of the invention, a longitudinal groove running parallel to the displacement direction of the clamping element can be formed in the outer wall of the axial region of the clamping element, in which longitudinal groove a limiting element retained fixedly in the base part engages, wherein the dimension of a head part of the limiting element engaging with the groove perpendicular to the axis of the groove substantially corresponds to the width of the groove, so that a rotational movement of the clamping element is substantially blocked and a translational movement of the clamping element is enabled.

In this manner, it is no longer necessary to provide a pin running parallel to the axis of the threaded spindle of the threaded sleeve and engaging with a corresponding recess or bore in the base part, on the clamping jaw or the clamping element, wherein a rotational movement of the clamping element is blocked due to the eccentric arrangement of the pin in relation to the displacement axis. In particular, the expense that results from a sufficiently precise production of the pin or the bore receiving it can be avoided.

The head part of the limiting element can be formed so as to expand in the direction perpendicular to the longitudinal axis of the groove resiliently or under pressure by means of a control element, in order to minimize or completely prevent a rotational movement of the clamping element.

The head part can be formed in two parts, wherein each part impinges on a side wall of the groove and a recess is formed in the sides of the two parts facing one another, the two recesses together forming an engagement recess for a pin element retained stationary in the base part perpendicular to the longitudinal axis of the groove. The end of the pin element engaging with the engagement recess and/or the recesses in the two parts have a conicity such that the two parts are moved in the direction toward the two side walls of the groove or apply an increasing pressing force thereto as the engagement of the pin element with the engagement recess increases.

The pin element can be formed as a screw, so that as the pin element is screwed further into a bore receiving said pin element in the base body, the parts forming the head part are spread apart sufficiently that a practically play-free guidance of the clamping element results while simultaneously suppressing any rotational movement of the clamping element.

The axial length of the groove can be selected in relation to the axial dimension of the head part in such a manner that, in connection with the axial limiting walls of the groove, the head part simultaneously serves as an axial stop for one or both movement directions of the clamping element.

Additional embodiments of the invention can be found in the subordinate claims.

The invention will be described in detail below with reference to embodiments illustrated in the drawings. In the drawings:

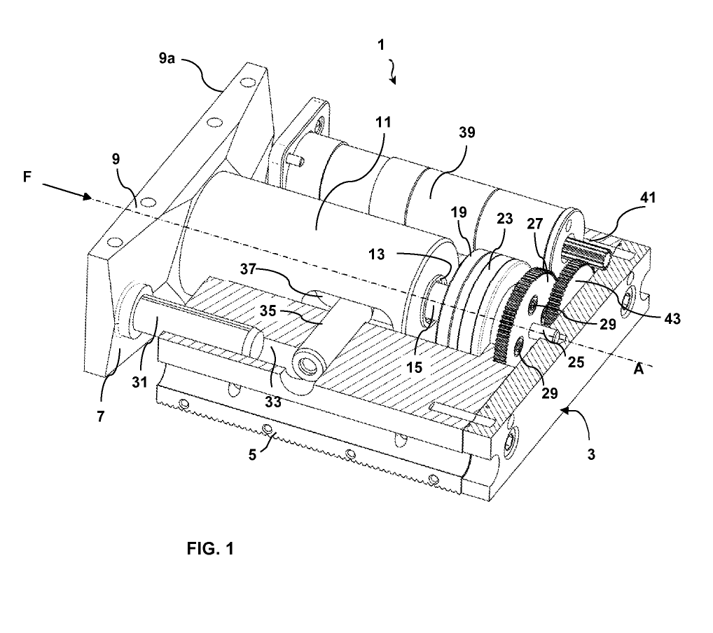

FIG. 1 shows a perspective, partially cut-away view of a module-like clamping device according to the invention with a rotationally driven threaded spindle;

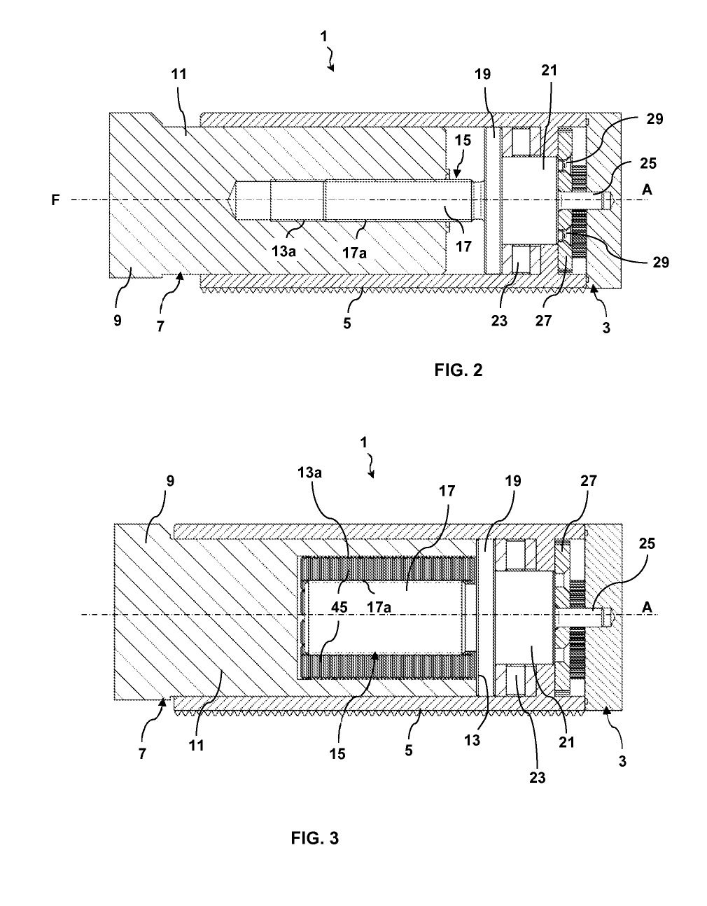

FIG. 2 shows a vertical section through the longitudinal axis of the clamping module in FIG. 1;

FIG. 3 shows a section similar to FIG. 2 through a second embodiment of a clamping module according to the invention with a threaded roller drive and

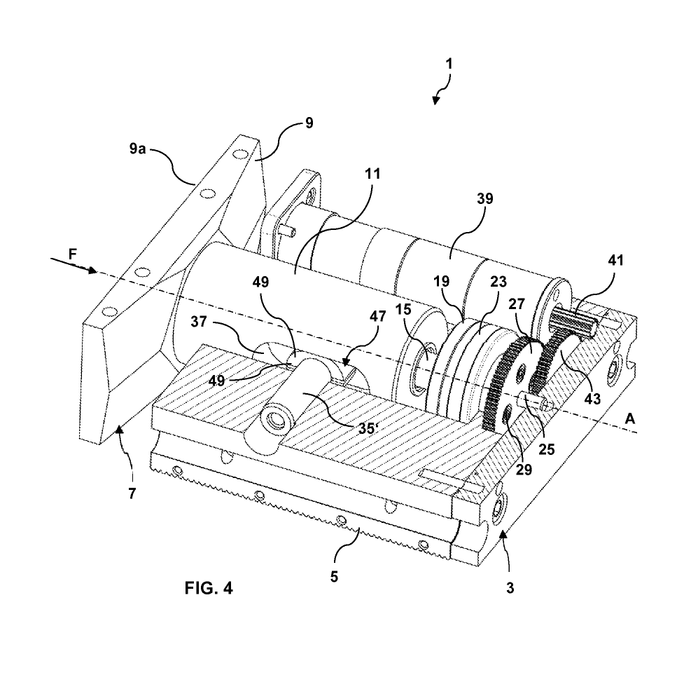

FIG. 4 shows a perspective, partially cut-away view of a third embodiment of a module-like clamping device according to the invention, with a similar device for rotational fixation of the clamping element;

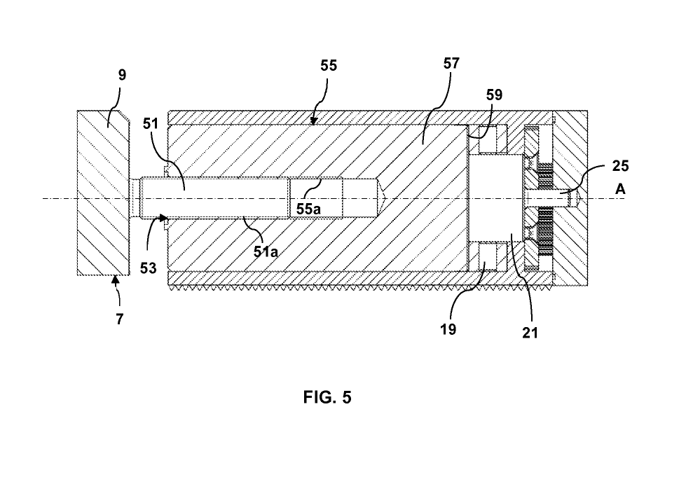

FIG. 5 shows a vertical section through the longitudinal axis of a fourth embodiment of a module-like clamping device according to the invention with a rotationally driven threaded sleeve; and

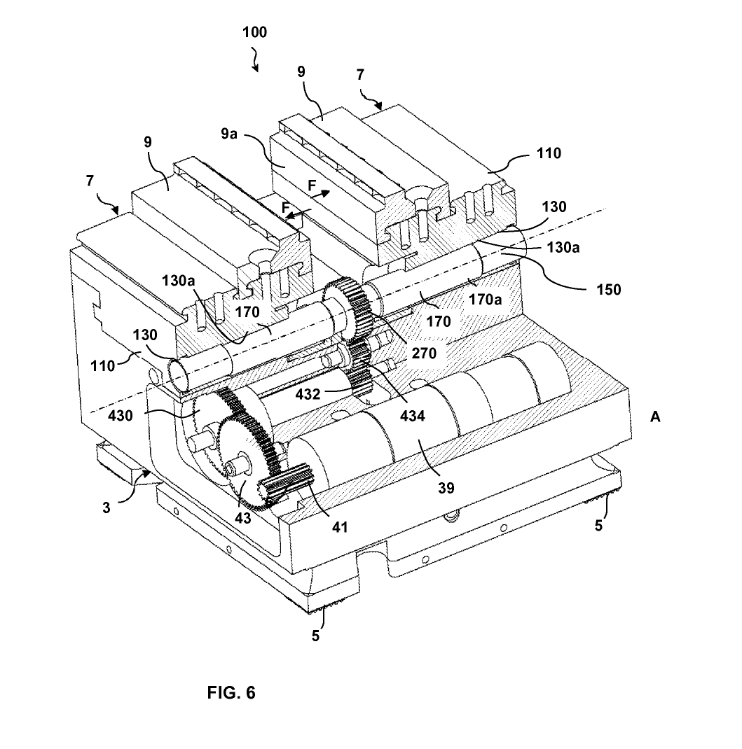

FIG. 6 shows a perspective, partially cut-away view of a fifth embodiment of a module-like clamping device according to the invention with two oppositely displaceably driven clamping elements.

The clamping device 1, shown in perspective and partially cut away in FIG. 1, is designed in the form of a clamping module and has a base part 3, which can be formed as in the illustrated embodiment so that it completely encloses the other components to the extent possible. In this manner, the other components are securely fixed in the base part 3 and are protected from environmental influences.

It is of course also possible to design the base part 3 as a carrier part, on top of or along which the other components of the clamping device 1 are arranged. As shown in FIG. 1 and FIG. 2, the base part 3 can have toothing 5 on its lower side, with which the clamping device 1, or the clamping module, can be fixed on the carrier element such as a rail by means of additional fastening elements, not shown in detail. For this purpose, the toothing 5 can cooperate with complimentary toothing of the carrier element.

In the embodiment according to FIGS. 1 and 2, the base part 3 encloses a clamping element 7, displaceably arranged relative to the base part 3 and having a clamping jaw 9 and an axially extending region 11 connected thereto, in which an axial threaded bore 13 is formed.

The axially extending region 11 can be formed substantially rotationally symmetrically with respect to the axis A of the threaded bore. The clamping jaw 9 connected to the axially extending region 11 can be formed symmetrically relative to a plane running vertically through the axis A, so that a clamping force F that is generated by the clamping device 1 or that must be absorbed thereby can be transmitted via an impingement surface 9a to the clamping device 1 without a large tilting moment on the axis A, at least if a part to be clamped (not shown) is impinged upon correspondingly centrally (or correspondingly symmetrically relative to the longitudinal center plane of the clamping element), by means of the impingement surface 9a of the clamping jaw 9 or of the clamping element 7.

The threaded spindle 13 engages with a threaded bore 15 in the axially extending region 11 of the clamping element 7. As can be seen from FIG. 2, the threaded spindle 15 has a front region 17 that is furnished with an external thread 17a, which cooperates with a corresponding internal thread 13a of the threaded bore 13.

Adjoining the rear end of the threaded spindle, i.e. the end facing away from the axially extending region 11 of the clamping element 7, the threaded spindle 15 has a flange region 19 that is adjoined by a bearing region 21. In relation to the front region 17, the bearing region 21 has an enlarged diameter, with which the threaded spindle 15 penetrates through an axial bearing 23. The bearing 23 is supported in the axial direction with its end facing away from the flange region 19 of the threaded spindle 15 against a corresponding portion of the base part 3. The front end of the axial bearing 23, which is preferably formed as a rolling-contact bearing, is impinged upon by the respective annular portion of the rear end face of the flange region 19. In this manner, the threaded spindle is fixed in the axial direction and is rotatably mounted about the axis A.

The axial bearing 23 can additionally take on the function of a radial bearing, so that the threaded spindle 15 is simultaneously supported radially in the bearing region 21 in addition to the axial bearing in order to transmit the pressing force F onto the base part 3.

A centering pin 25, which engages with a corresponding recess in the rear side wall of the base part 3, is arranged at the rear end of the bearing region 21 of the threaded spindle 15. The centering pin 25 is thus used for centering the threaded spindle 15 during assembly and, if appropriate, also during operation of the clamping device, i.e. during rotary driving of the threaded spindle 15.

The centering pin 25 is additionally used for receiving and centering a drive pinion 27, which is pushed with a coaxial bore onto the centering pin 25 and is connected for conjoint rotation to the spindle 15 by means of screws 29.

As can be seen from FIGS. 1 and 2, the axially extending region 11 of the clamping element 7 is held displaceably in the direction of the axis A in a corresponding recess in the base part 3. The clamping element 7 is thus moved into or out of the base part 3 by means of rotational driving of the threaded spindle 15. The clamping device 1 is thus capable of cooperating with another clamping module that is stationary or is likewise movable (but can be fixed in the clamping position) and of fixing a component to be fixed with a predetermined clamping force. The clamping force F is generated by the below-described driving of the clamping device 1.

In the embodiment of the clamping device 1 illustrated in FIG. 1, the rotation of the clamping element 7 about the axis of rotation or displacement A is effected by a pin 31, which is provided eccentrically to the axis A and is connected to the clamping jaw 9 of the clamping element 7. The axis of the pin 31 extends parallel to the axis A of the threaded bore 13, about which the threaded spindle 15 rotates and which defines the displacement direction of the clamping element 7. It goes without saying that the axis of the pin 31 must be aligned sufficiently precisely with the axis of the corresponding receiving bore or receiving recess in the base part 3 so that the displacement movement of the clamping element 7 is not hindered in the entire predefined axial displacement range. This naturally requires maintaining correspondingly tight production tolerances.

The axial displacement path of the clamping element 7 is effected in the embodiment shown in FIG. 1 by a stop pin 35, which is retained substantially perpendicular to the displacement movement in the base part 3 and which engages with its front end, which is facing the axially extending region 11 of the clamping element 7, with a longitudinal groove 37 in the outer periphery of the axially extending region 11. The position and length of the longitudinal groove 37 in relation to stop pin and the diameter or dimensions of the stop pin 35 define the maximum possible displacement path or the end positions of the displacement movement of clamping element 7.

The motor-powered driving for the threaded spindle 15 is accomplished via a motor 39, which can be embodied as an electric motor but preferably as a pneumatic motor. The motor 39 is, as can be seen from FIG. 1, arranged alongside the axially extending region 11 or alongside the threaded spindle 15 inside the axial length of these two cooperating elements. This achieves an extremely short construction for such a motor-driven clamping device, which is sufficiently narrow due to the elongated dimensions of the motor, and also has a relatively small overall height.

The motor 9 has an output in the form of a rotationally driven driving pinion 41. In the embodiment illustrated in FIGS. 1 and 2, the output pinion 41 and the driving pinion 27 of the threaded spindle 15 are coupled via a double pinion 43, wherein the output pinion 41 is coupled to a larger gear rim of the double pinion 43 and the smaller gear rim of the double pinion 43 is coupled to the driving pinion 27. The double pinion 43 is of course rotatably mounted in the required position in the base part 3.

This yields an extremely simple drive unit, formed from the motor 39, a gear unit formed by the pinions 41, 43 and 27 and the rotatable, axially fixedly mounted threaded spindle 15, for the clamping element 7.

The drive unit is designed overall such that self-locking exists, i.e. there must not be any displacement of the clamping element 7 up to the maximum possible clamping force that can be generated by the clamping device 1 or that is to be absorbed thereby (nominal clamping force).

The clamping force can therefore be maintained at its full level even if the motor 39 is disconnected from any type of energy supply.

In order to be able to use the lowest powered, and therefore smallest, motor 39 possible, a gear unit with a correspondingly high transmission ratio can of course be used. In addition, the mechanical losses in the part of the drive unit for the clamping element 7 that is connected downstream of the motor, particularly the frictional losses in the gear unit and the frictional losses in the bearing of the threaded spindle 15, as well as the losses due to friction between the internal thread 13a of the axially extending region 11 of the clamping element 7 and the external thread 17a of the threaded spindle 15, should be kept as small as possible.

More particularly, the internal thread 13a and/or the external thread 17a can be coated with a friction-reducing coating for this purpose. A DLC coating, for example, can be considered for this purpose.

However, special lubricants can also be used to reduce the friction between these components.

The axial bearing 23 also contributes particularly to reducing frictional losses. If one were to use an axial sliding bearing at this point rather than an axial rolling-contact bearing, there would be a drastically increased moment of friction about the shaft A.

Another dimensioning rule to be considered is that the diameter of the front region 17 of the threaded spindle 15 bearing the outside thread 17a, or the diameter of the cooperating threaded bore 13, should be kept sufficiently small. The moment of friction to be overcome by the drive unit, particularly the motor 39, increases with the effective lever arm about the axis A, i.e. with the diameter of the thread flanks, i.e. the effective diameter of the helical linear contact between the threaded spindle and the threaded bore.

In addition, the threaded spindle must be capable of generating the desired maximum pressing force or nominal pressing force, or of transmitting it to the base part 3, without the occurrence of damage to the clamping device 1 or an unacceptable reduction of the service life of the device. It goes without saying that a certain minimum thickness of the threaded spindle and/or a corresponding formation of the thread are necessary.

The following estimation can be used for estimating the torque which is required from the drive unit, including the gear unit, to transmit the driving torque to the threaded spindle in order to generate a desired pressing force F:

The torque D₀, which must be transmitted to the threaded spindle without taking any frictional losses into account in order to generate the pressing force F, follows from the relationship

D₀=F·h/2π

where h refers to the pitch height of the thread.

The torque DG, which is generated by the thread, or the interaction of the external thread 17a of the threaded spindle 15 and the internal thread 13a of the threaded bore 13 in the clamping element 7, follows from the relationship:

D_{G}=F·r₀·μᵣ

where r₀ designates the flank radius of the thread or threads and μᵣ designates the coefficient of friction (sliding friction) between the interacting threads.

A value of approximately μᵣ=0.14, as is typical for screw calculations, can be assumed as a value for the coefficient of friction. The coefficient of friction μᵣ can be reduced to approximately μᵣ=0.09 by using special coatings or lubricants.

The moment of friction DL caused by the axial bearing can be determined with the relationship

D_{L}=F·R₀·μ_{R}

where R₀ designates the radius of the rolling element raceway and μ_{R} designates the coefficient of friction for the rolling friction in the rolling-contact bearing. A value of μ_{R}=0.002, as is typical for rolling-contact bearing calculations, can be assumed for the coefficient of friction for the rolling friction.

Thus, the drive unit must generate a drive torque D_{AN} that is to be transmitted to the threaded spindle in order to generate the desired pressing force F that results from the sum of the torques D₀, D_{G} and D_{L}, i.e. according to the relationship:

D_{AN}=D₀+D_{G}+D_{L}

The ratio η of the torque D₀ that must be applied to generate the pressing force F (without any friction) to the drive torque D_{AN} that must be applied, taking friction into account, thus follows as:

η=D₀/(D₀+D_{G}+D_{L})

If an M12x1 thread is used as the thread for the threaded spindle, having a thread flank diameter of 10.8 nun and a pitch height of 1 mm, a torque D₀ of 6.37 Nm, which must be applied without frictional losses to generate a nominal pressing force of 40 kN results. With a flank diameter 10.8 mm and a coefficient of friction of 0.14, as is typical for screw calculations, a moment of friction of D_{G}=30.24 Nm for the thread or the interacting thread results.

If an axial bearing having a rolling body raceway radius R₀ of 15 mm is used, which surrounds the bearing region 21 of the threaded spindle 15 and on which the flange region 19 is supported, then a moment of friction D_{L}=1.2 Nm for the axial rolling-contact bearing results, with an assumed coefficient of friction of 0.002, as is typical for rolling-contact bearing calculations.

With these values, a ratio η=16.8% results, i.e. 16.8% of the driving torque D_{AN} contributes to generating the nominal pressing force (independently of the value thereof).

If coatings are used for the interacting threads of the threaded spindle 15 and the clamping element 7, or if special lubricants are used to reduce the friction, then a value for the ratio η=23.6% results for a reduced coefficient of friction μᵣ=0.09.

Using the above relationships, the threaded spindle 15 and the axial bearing 23 can easily be dimensioned such that a maximum component of the drive torque D_{AN} that is transmitted to the threaded spindle 15 contributes to the generation of the axial force.

As explained above, in order to generate an axial force of 40 kN, for example, an M12x1 thread can be used and the support of the threaded spindle 15 can be accomplished by means of an axial bearing having a radius of 15 mm for the rolling element raceway. In this case, the overwhelming proportion of the moment of friction to be overcome goes back to the thread of the threaded spindle 15 and the threaded bore 13 in the clamping element 7, so that the influence of the axial rolling-contact bearing 23 can be neglected to a first approximation. By using a friction-reducing coating such as a DLC coating for the threads or by using special lubricants, the proportion of the total drive torque D_{AN} used exclusively for generating the pressing force can be improved from a value of η=16.8% to a value of η=23.6%.

On the other hand, if the axial rolling-contact bearing 23 were to be foregone and replaced by an axial sliding bearing, then less than 7% of the drive would contribute to generating the axial force.

The additional embodiment of a clamping device 1 according to the invention illustrated in the vertical section along the axis A in FIG. 3 shows a possibility for further reduction of the frictional losses when transmitting the pressing force F between the clamping element 7 and the threaded spindle 15. In this case, a threaded spindle 15 is used with a front region 17 which can have a larger diameter than in the case of the variant according to FIGS. 1 and 2. The diameter of the threaded hole 13 in this case is chosen to be considerably larger than the outer diameter of the threaded spindle 15 in the front region 17. A plurality of threaded rollers 45 are used in the annular gap between the internal thread 13a in the axially extending region 11 and the external thread 17a of the front region 17 of the threaded spindle 15, the threads or pseudo-threads of the threaded rollers interacting with the internal thread 13a or the external thread 17a.

The threaded rollers can be formed such that, in place of a thread in the actual or strict sense, a degenerate thread with a pitch of 0 is formed on the periphery of the threaded rollers, which consists of a corresponding number of circumferential grooves arranged in the spacing specified by the internal thread 13a or the external thread 17a.

Such a threaded roller drive has the effect that, in place of a sliding friction between the interacting strands, only the lower rolling friction appears. Therefore, the diameter of the threaded spindle can be selected to be larger in this case, with the same ratio η as in the embodiment of FIG. 2. However, this variant is of course more expensive, so that the previously explained embodiment with a threaded spindle having correspondingly smaller radius and the use of a friction-reducing coating or a special lubricant represents a good compromise, which still makes it possible to use a correspondingly small-dimensioned motor that can be arranged alongside the threaded spindle or the axially extending region of the clamping element 7, and is nonetheless sufficient to generate the required torque in combination with the remaining drive components.

The additional embodiment of a clamping device 1 shown in a perspective and partially cut-away view in FIG. 4 differs from the embodiment according to FIGS. 1-3 by dispensing with an additional pin oriented perpendicular to the displacement axis or the axis of rotation A for preventing the rotational movement of the clamping device 7. This eliminates the expense for realizing a guide provided eccentrically to the axis A for anti-rotation protection by the pin 31 and the bore 33, for which it is necessary to maintain correspondingly tight tolerances in relation to the parallelism of the axes of the pin and the bore with the displacement axis A and possibly in relation to the outside diameter of the pin and the inside diameter of the bore in order to avoid jamming on the one hand and to avoid any rotational play to the extent possible on the other.

Rotational movement is prevented in the embodiment according to FIG. 4 by a specially designed stop pin 35′, the conical tip of which engages with a head part 47. The stop pin 35′ and the head part 47 form a limiting element that engages with the longitudinal groove 27 as freely of play as possible in the azimuthal direction of the axially extending region 11 of the clamping element 7. Firstly, even slight rotational movements of the clamping element 7 about the axis A are prevented in this way, and secondly, an additional guidance of the displacement movement of the clamping element 7 is achieved.

In the embodiment of a clamping device 1 shown in FIG. 4, the stop pin 35′ engages with a head part 47 formed in two parts, wherein the facing sides of the two head part halves 49 each have a conically running recess in the axis of the stop pin 35′, in which recess a forward, likewise conically formed part of the stop pin 35′ engages. The division of the head part 47 into the two head part halves 49 can run in the longitudinal center plane of the longitudinal groove 37 (running horizontally), as in the illustrated embodiment. In this manner, the head part halves 49 can move apart from one another due to an inward movement of the stop pin 35′, so that the outer surfaces of the head part halves 49 facing the longitudinal side walls of the longitudinal groove 37 apply a (relatively small) contact pressure to the longitudinal side walls of the longitudinal groove 37, whereby the freedom from play in the guidance of the displacement movement of the clamping element 7 is achieved, or even slight rotational movements of the clamping element 7 are prevented in any possible displacement position.

To fix the stop pin 35′ in its longitudinal direction, the stop pin can have an external thread, for example, with which it can be screwed into a matching threaded bore in the base part 3. By choosing an appropriate screw-in depth, the desired spreading of the head part 47 can then be achieved.

Of course the head part 47 can also be formed in one piece and can be spread out in the desired direction by means of a solid body joint or an extensible region, in order to guarantee the necessary lack of play.

According to another embodiment, the limiting element can also have a head part, which is formed to spread open resiliently on its own in the direction transverse to the longitudinal direction of the longitudinal groove 37. The head part is dimensioned such that, during insertion of the head part into the longitudinal groove, a desired pre-tensioning of the head part is achieved, whereby the desired lack of play can in turn be guaranteed.

It should be noted at this point that the displaceable movement of the clamping element can also be achieved by using, in place of a threaded spindle engaging in the axially extending region 11 and driven rotationally, a rotationally driven threaded sleeve, which cooperates with a threaded rod of the clamping element 7. Thus, the axially extending region 11 of the clamping element in this case is constructed as a threaded rod, which engages with a threaded bore of the rotationally driven element (the threaded sleeve). Such an embodiment is shown in FIG. 5. The clamping element 7 has a threaded rod 51 that engages with a threaded bore 53 of a rotationally driven threaded sleeve 55. The threaded rod 51 has an external thread 51a that cooperates with an internal thread 53a of the threaded sleeve 55.

The threaded sleeve 55 in turn has a bearing region 21 adjoining a front region 57 of the threaded sleeve 55, and a centering pin 25 adjoining the bearing region 21. These parts or components, or regions, including the axial bearing 19 for the axial and optionally additional radial support of the threaded sleeve 55, are identical to the corresponding parts or regions or components of the embodiments according to FIGS. 1-4, and therefore the reader is referred in this regard to the above explanations in the description.

The threaded sleeve 55 is supported on the axial bearing 19 via an annular shoulder 59 between the front region 57 and the bearing region 21 of the threaded sleeve 55, which arises from the fact that the bearing region 21 has a smaller diameter than the front region 57 of the threaded sleeve 55. The threaded sleeve 55 preferably has a circular cylindrical outer diameter over the entire axial length, so that easy bearing is possible.

Of course, a radial support can also be provided here in the front region 57, for example by means of a corresponding radial bearing between the outer circumference of the front region 57 and the inner circumference of the corresponding circular cylindrical receiving recess in the base part 3.

Anti-rotational locking of the clamping element 7 can be implemented in this embodiment correspondingly to the variant shown in FIG. 1, by means of a pin 31, which engages with a receiving bore 33 of the base part 3.

The above explanations regarding the dimensioning and design or lubrication of the threads for generating the displacement movement of the clamping element 7 can also be transferred analogously to the embodiment according to FIG. 5.

Thus, the invention creates a clamping device, particularly in the form of a clamping module, which has a motor-driven clamping element and has small dimensions, particularly with respect to the length of the clamping device. In addition, the clamping device can be designed in a simple manner such that there is self-locking even when an energy supply for the motor drive unit is lacking, which guarantees that the clamping force is maintained at its full level even without connection to an energy supply.

FIG. 6 shows an embodiment of a clamping device 100 in the form of a clamping module with two clamping elements 7 that can be driven in opposite directions. The special features of this embodiment will be described below. The reader is referred to the above discussions for explanation of the elements that substantially match the corresponding embodiments 1 and 4.

The clamping elements 7 in this case each have an axially extending region 110, the width of which corresponds to the width of the clamping jaws 9. The clamping elements are guided displaceably with the axially extending region by means of a swallowtail-like guide in the housing 3. The clamping elements 7 or the axially extending regions 110 have, in the central plane thereof, a threaded bore 130 that has an internal thread in a predetermined axial section 130a.

The clamping device 100 comprises a threaded spindle 150 that engages with a respective threaded region 170 in a threaded bore 130 of the respective clamping element. The length of the threaded spindle is selected so as to allow the desired displacement path for the two clamping elements 7.

The external threads 170a of the threaded spindle 150 in the threaded regions 170 are designed and interact with the internal threads 130a of the threaded bores 130 in such a manner that when the threaded spindle 150 is driven in one rotational direction, the clamping elements 7 are moved in the one displacement direction, for example toward one another, and are moved in the respective other displacement direction, apart from one another for example, when driven in the opposite rotational direction. For this purpose, a left-hand thread is preferably used in one of the threaded regions 170 and the associated threaded bore 130 and a right-hand thread is used in the respective other threaded region 170 of the associated threaded bore 130.

The threaded spindle 150 is driven via a pinion 270 that is provided in a driving region of the threaded spindle 150. It can preferably be arranged between the two threaded regions 170. In this manner, it is possible to move the clamping elements 7 sufficiently far to the outside that the threads are no longer engaged, in order to dismantle the clamping device in this manner. This design also allows a shorter construction than the provision of the drive region in one of the end regions of the threaded spindle 150.

The threaded spindle 150 need not be axially supported, because practically no axial forces occur that could cause a displacement of the threaded spindle. For axial fixation of the threaded spindle 150, a lateral or axial stop can be provided on both sides of the pinion 270, as shown in FIG. 6. In order to assemble the clamping device 100, the threaded spindle 150 with the pinion 270 need only be inserted between the stops, and the clamping elements 7 must be pushed sufficiently from the outside with the threaded bores 130 onto the threaded spindle 150 and inserted into the swallowtail-like guide until the threads are brought into engagement. The clamping elements 7 can then be moved further toward one another by driving the threaded spindle 150. Subsequently, stops, not shown, can be installed that limit the movement of the clamping elements 7 to the outside so that they cannot unintentionally become disengaged from the threaded spindle 150.

The threaded spindle 150 is again driven via a gear unit, which is formed in a suitable manner. In the embodiment according to FIG. 6, the double pinion 43 cooperates with an additional pinion 430, the shaft of which is formed sufficiently long that a pinion 432, which is arranged at the other end of the shaft and lies in the plane of the pinion 270, drives the threaded spindle 150 via a further pinion 434, which is likewise seated in the housing 3. The pinion 434 can of course also be omitted if the diameters of the pinions 270 and 432 are constructed such that they directly mesh.

It goes without saying that all variants previously described in connection with the embodiments according to FIGS. 1-5 having a single displaceably driven clamping element can also be apply to embodiments with two oppositely driven clamping elements, to the extent that this makes sense. For example, a guide in an axially extending region having a narrower width than the clamping jaws can be used in place of a swallowtail-like guide for the clamping elements (see FIG. 1). The motor-driven threaded spindle or threaded sleeve can be guided in such a variant through the clamping jaws 9, but can also run underneath the level of the clamping jaws, i.e. the clamping jaws are arranged higher than the axially extending region in comparison to the embodiment according to FIG. 1 and are integrally formed therewith or detachably connected thereto.

The motor 39 can of course also be arranged in the region of a single one of the two clamping elements 9 in order to enable a narrower construction (analogously to FIGS. 1-5, but with a second clamping element 9 arranged in the housing 3).

If a narrower construction is not necessary, then the motor can also be arranged outside or alongside, i.e. laterally offset, and below the clamping element.

It goes without saying that all variants for preventing a rotational movement of the clamping element 7, as described in FIGS. 1-4, can also be combined with an embodiment having two oppositely driven clamping elements.

The threaded roller drive as described above can also be used for driving the clamping elements. The threaded roller drive can also be used, as in the case of embodiments according to FIGS. 1-5, for coupling a motor-driven threaded sleeve with one or both threaded rods of the clamping elements 7. In this case, the threaded rollers are arranged between the internal thread of the threaded sleeve and the external thread of the threaded rod of the clamping element or elements 7. The threaded rods of the clamping elements 7 extend in this case from the end region of the axial region of each clamping element 7 in the direction of the front region, i.e. in the direction of the clamping jaw. The threaded sleeve can thus cooperate with its threaded regions arranged on each side with the respective threaded regions of the relevant threaded rod.

### LIST OF REFERENCE NUMBERS

1 Clamping device
3 Base part
5 Toothing
7 Clamping element
9 Clamping jaw
9a Impingement surface
11 Axially extending region
13 Axial threaded bore
13a Internal thread
15 Threaded spindle
17 Front region
17a External thread
19 Flange region
21 Bearing region
23 Axial bearing
25 Centering pin
27 Drive pinion
29 Screws
31 Pin
33 Bore
35 Stop pin
35′ Stop pin
39 Motor
41 Output pinion
43 Double pinion
45 Threaded roller
47 Head part
49 Head part halves
51 Threaded rod
51a External thread
53 Threaded bore
53a Internal thread
55 Threaded sleeve
57 Front region
59 Annular shoulder
100 Clamping device
110 Axially extending region
130 Threaded bore
130a Internal thread
150 Threaded spindle
170 Threaded region
170a External thread
270 Pinion
430 Pinion
432 Pinion
434 Pinion
A Axis of rotation, threaded spindle/threaded sleeve
F Clamping force
R₀ Radius of the rolling body raceway
r₀ Flank radius
μᵣ Coefficient of friction (sliding friction)
μ_{R} Coefficient of friction (rolling friction)
h Pitch height
D₀ Torque to be transmitted to the threaded spindle/threaded sleeve in order to generate the pressing force F, without taking frictional losses into account
D_{G} Moment of friction, threaded spindle/threaded sleeve
D_{L} Moment of friction, axial bearing/sliding bearing
D_{AN} Torque to be transmitted to the threaded spindle/threaded sleeve in order to generate the pressing force F, taking the moments of friction D₀, D_{L}, D_{G} into account

1. Clamping device, particularly a clamping module, having
(a) a base part (3),
(b) a clamping element (7) arranged such that it can be displaced relative to the base part (3), having an impingement surface (9a) for transmitting a clamping force onto a part to be clamped, and
(c) a drive unit that impinges displaceably onto the clamping element (7),
characterized in that
(d) the drive unit has a threaded spindle (15, 150) that can be rotationally driven by a motor (39), the threaded spindle engaging with a threaded bore (13, 130) having an internal thread (13a, 130a) in the clamping element (7),
(e) wherein the external thread (17a, 170a) of the threaded spindle (15, 150) cooperates directly or indirectly with the internal thread (13a, 130a) of the bore (13, 130) in such a manner that a rotational driving of the threaded spindle (15 150) generates a displacement of the clamping element (7) and/or a clamping force (F), or
(f) in that the drive unit has a threaded sleeve (55) with an internal thread (53a), that can be rotationally driven by a motor (39), into which threaded sleeve a threaded rod (51) of the clamping element (7) engages,
(g) wherein the external thread (51a) of the threaded rod (51) cooperates directly or indirectly with the internal thread (53a) of the threaded sleeve (55) in such a manner that a rotational driving of the threaded spindle (55) generates a displacement of the clamping element (7) and/or a clamping force (F).

2. Clamping device according to claim 1, characterized in that the diameter of the threaded spindle (15, 150) or the inside diameter of the threaded sleeve (15) is selected sufficiently small that at least 10% of the drive torque, preferably at least 15%, and most preferably at least 25% of the drive torque transmitted to the drive-side end of the threaded spindle (15, 150) or the threaded sleeve (55) contributes to producing the clamping force (F) that can be derived at the impingement surface (9a) of the clamping element (7).

3. Clamping device according to one of the preceding claims, characterized in that the pitch of the internal and external thread (13a, 130a, 17a; 170a; 53a, 51a) of the threaded spindle (15, 150) and of the bore (13, 130) of the clamping element (7), or of the threaded sleeve (55) and the threaded rod (51), is selected depending on the friction forces occurring between the respective elements in such a manner that self-locking exists in the range up to a maximum predetermined nominal clamping force.

4. Clamping device according to one of the preceding claims, characterized in that the external thread (17a, 170a) of the threaded spindle (15, 150) and/or the internal thread (13a, 130a) of the bore (13, 130) of the clamping element (7), or the internal thread (53a) of the threaded sleeve (55) and/or the external thread (51a) of the threaded rod (51), are furnished with a coating that reduces friction.

5. Clamping device according to one of claims 1-4, characterized in that the clamping device has a single displaceable clamping element (7) and in that the threaded spindle (15) or the threaded sleeve (55) has a flange region (19, 59) with an end face running perpendicular to the axis of rotation (A) of the threaded spindle (15) or the threaded sleeve (55) and facing away from the impingement surface (9a) of the clamping element (7), with which end face the threaded spindle (15) or the threaded sleeve (55) is supported against an axial bearing arranged (23) stationarily in or on the base part (3).

6. Clamping device according to one of claims 1-4, characterized in that the clamping device has two clamping elements (7) that can be displaced in opposite directions by means of a single drive, and that a single rotationally drivable threaded spindle (150) of the drive unit can cooperate in a respective threaded region (170) with the respective threaded bore (130) of each of the two clamping elements (7), or a single rotationally drivable threaded sleeve of the drive unit can cooperate, directly or indirectly, in a respective threaded region with the respective threaded rod of each of the two clamping elements (7) in such a manner that, in one rotational direction of the drive unit, the two clamping elements (7) are moved in one displacement direction, and the two clamping elements are moved in the other displacement direction in the other rotational direction of the drive unit.

7. Clamping device according to one of the preceding claims, characterized in that the threaded spindle (15, 150) or the threaded sleeve (55) has a drive region which can be formed at an end region of the threaded spindle (15, 150) or of the threaded sleeve (55) and which is connected directly to the output shaft (41) of the motor (39) or via a gear unit (27, 43; 270, 430, 432, 434) to the output shaft (41) of the motor (39).

8. Clamping device according to claims 6 and 7, characterized in that the drive region is provided between the two threaded regions (170) of the threaded spindle or the threaded sleeve.

9. Clamping device according to claim 7 or 8, characterized in that the gear unit (27, 43; 270, 430, 432, 434) is formed to be self-locking or in that the gear unit (27, 43) is formed such that self-locking is achieved in connection with the drive part formed by the threaded spindle (15) and the bore (13) in the axial region (11) of the clamping element (7) or with the drive part formed by the threaded sleeve (55) and the threaded rod (51) of the clamping element (7).

10. Clamping device according to one of the preceding claims, characterized in that the motor (39) is a pneumatic motor, preferably a rotary vane motor, a hydraulic motor or an electric motor.

11. Clamping device according to one of the preceding claims, characterized in that the motor (39) is arranged in the base part substantially alongside and/or underneath the threaded bore of the clamping element (7) and the threaded spindle (15) of the drive unit, or alongside and/or below the threaded rod of the clamping element (7) and the threaded sleeve (55) of the drive unit.

12. Clamping device according to claim 11, characterized in that the motor (39) preferably has a longitudinal axis aligned with the axis of rotation of the output shaft (41), and the motor (39) is arranged such that the longitudinal axis of the motor runs parallel to the axis of rotation (A) of the threaded spindle (15, 150) or the threaded sleeve (55).

13. Clamping device according to one of the preceding claims, characterized in that a plurality of bearing rollers (45) are provided between the external thread (17a, 170a) of the threaded spindle (15, 150) of the drive unit and the internal thread (13a, 130a) of the bore (13, 130) in the axial region (11) of the clamping element (7), or between the internal thread (53a) of the threaded sleeve (55) of the drive unit and the external thread (51a) of the threaded rod (51) of the clamping element (7) in order to form a threaded roller drive.

14. Clamping device according to one of the preceding claims, characterized in that a longitudinal groove running parallel to the displacement direction of the clamping element (7) is formed in the outer wall of the axial region (11) of the clamping element (7), into which longitudinal groove a limiting element (35, 35′, 47) retained fixedly in the base part engages, wherein the dimension of a head part (35, 47) of the limiting element (35, 35′, 47) engaging with the groove (37) perpendicular to the axis of the groove (37) substantially corresponds to the width of the groove (37), so that a rotational movement of the clamping element (7) is substantially blocked and a translational movement of the clamping element (7) is enabled.

15. Clamping device according to claim 12, characterized in that the head part (47) of the limiting element (35′, 47) can be formed so as to expand in the direction perpendicular to the longitudinal axis of the groove (37), resiliently or under pressure by means of a control element (35′), in order to minimize or completely prevent a rotational movement of the clamping element (7).
